(19) United States
(12) Patent Application Publication
(10) Pub. No.: US 2014/0228458 A1
(43) Pub. Date: Aug. 14, 2014

(54) METHOD AND APPARATUS FOR RETICULATING FOAM MATERIAL USING SHOCK WAVES IN A GASEOUS ENVIRONMENT

(71) Applicants: Noureddine Atalla, Sherbrooke (CA); Martin Brouillette, Sherbrooke (CA); Oliver Doutres, Sherbrooke (CA); Christian Hébert, Sherbrooke (CA)

(72) Inventors: Noureddine Atalla, Sherbrooke (CA); Martin Brouillette, Sherbrooke (CA); Oliver Doutres, Sherbrooke (CA); Christian Hébert, Sherbrooke (CA)

(73) Assignee: SOCPRA- Sciences et Génie s.e.c., Sherbrooke, QC (CA)

(21) Appl. No.: 14/342,236

(22) PCT Filed: Aug. 28, 2012
(86) PCT No.: PCT/CA2012/000804

§ 371 Date: Mar. 11, 2014

Related U.S. Application Data
(60) Provisional application No. 61/528,921, filed on Aug. 30, 2011.

(51) Int. Cl. C08J 9/36; G05D 16/16; G10K 15/04

(52) U.S. Cl. CPC C08J 9/36; G10K 15/043; G05D 16/163
USPC 521/52; 137/828; 137/829; 422/127; 264/154

(57) ABSTRACT

The present document describes a method and apparatus to rapidly reticulate closed-cell or partially closed-cell foams. The method involves the propagation of an energy impulse inside the foam; the energy impulse can be a shock wave. The energy impulse is generated in the same gaseous environment in which the foam is immersed, preferentially air in room condition. The energy impulse destroys the membranes closing the foam cells without disintegrating the frame's structure. In particular, the method rapidly improves the acoustic and filtering behavior of the foams.

### BACKGROUND

(a) Field

The subject matter disclosed generally relates to acoustic and filter closed-cell or partially closed-cell foams, and a method to reticulate them. More particularly, the subject matter disclosed generally relates to a method and an apparatus for reticulating foams using shock waves in a gaseous environment.

(b) Related Prior Art

A closed-cell foam production is generally cheaper and simpler than an open-cell foam production. However, the acoustic or filtering efficiency of closed-cell foams is poor compared to open-cell foams because it is very difficult for the acoustic waves or flow impinging the closed-cell foam to penetrate inside. A method to improve the acoustic and filtering behavior of closed-cell foam is to remove the membranes, or the impermeable partition, closing the cell pores (known as reticulations). Furthermore, it is known that materials with gradient in their microstructure, resulting in gradient in properties along their thickness or surface, can show a great increase of their acoustic and filtering behaviors.

Depending on the nature and properties of the reticulated products, such as pore size, flexibility, and the like, the materials with open-cells are of utility as filtering devices (air filters, water filters, microphone filters, drill motor filter, base for ceramic filters, . . . ), sound insulating devices (for cars, planes, trains, machinery, buildings), gas-liquid contacting devices, catalyst carriers, rug anchors, door mats, drain pads, sponges, mattresses, pillows, tire liners, and the like.

A great number of methods have been proposed to reticulate closed-cell foams, mainly to improve their filtration or acoustic properties.

For example, a well-known method to reticulate closed-cell foams is reticulation by shock waves of a material immersed in a liquid. In this method, the material to be treated is immersed in a liquid bath. Subsequently, a projectile is fired at high speed in the liquid, which produces a pressure wave used to treat the material. The pressure wave in the liquid may also be produced by a high speed piston, or by a string of explosives. However, by using this particular method, the material to be treated must be immersed in a liquid environment. This implies a large number of undesirable restrictions in the context of an industrial process. Moreover, by using this process, after treatment, the material must undergo a prolonged drying step. Also, the liquid environment requires some attention to avoid contamination, in addition to associated plumbing, and the like. These disadvantages may explain the fact that this method is not very popular.

Another well-know method to reticulate closed-cell foams is thermal reticulation. In this method, the material to be treated is placed in a chamber under high pressure and high temperature. A quick depressurization creates a flow of hot gas through the material and partially destroys the membranes of the closed-cells by melting. However, this method of thermal reticulation may not be applied in a continuous process. Also, the materials must be cooled after treatment. Moreover, by using this method, it is impossible to control the gradient of reticulations depending on the thickness or the surface (i.e., a pattern of reticulations) of the material to be treated.

Yet another well-know method to reticulate closed-cell foams is mechanical reticulation. According to this method, the material to be treated is cut into thin slices which are then compressed to a high compression ratio between rollers. This method is suitable for materials having a flexible skeleton (e.g., polyurethane). However, this method is not efficient enough because it does not significantly remove the closed-cell membranes.

Another well-know method to reticulate closed-cell foams is reticulation by gas. In this particular method, the material to be treated is placed in a tank filled with combustible gas. Ignition of the gas causes a controlled explosion that removes the thin membranes by the combined action of heat and blast wave caused by the explosion. However, this method cannot be applied in a continuous process. Moreover, the materials must be cooled after treatment. In addition, by using explosives, this method has a potential danger to security. Also, by using this method, it is impossible to control the gradient of reticulations depending on the thickness or the surface (i.e. a pattern of reticulations) of the material to be treated.

Still another well-know method to reticulate closed-cell foams is chemical reticulation. In this method, the material to be treated is placed in a chemical bath which reacts with the foam material to destroy membranes of the closed-cells. Chemical concentration, bath temperature and speed of passage of the material in the bath may be controlled accordingly. In another similar method, the chemical product is poured on the surface of the material to be treated for a capillary action. However, this method results in an expensive process, may use hazardous materials and Can produce a strong inhomogeneity of the surface and the volume of the treated material.

Another well-know method to reticulate closed-cell foams is the hydraulic reticulation. In this method, a water or air jet at high velocity is sent over the material to be treated. However, in this method, the structure of the material may be damaged and the liquid or air flow may be hardly homogeneous over a large surface area. Furthermore, the material must be dried after treatment in the case of the water jet reticulation.

The disadvantages of the foregoing methods for destroying cell membranes are varied. Many of such methods are efficient, yet may be uneconomical, slow, involve chemical products and/or immersion of the foam in a fluid, require drying or cooling the foam after treatment, and may be difficult to control. Furthermore, most of such methods do not allow controlling the reticulation rate along the foam thickness nor locally along the surface of the material and thus are unable to create a Functionally Graded Material (FGM).

For example, the gas explosion method described in U.S. Pat. No. 2,961,710 treats a foam block as a whole. The water shock treatment method described in U.S. Pat. No. 3,239,585 claims a uniform reticulation process but is unable to treat quickly and differently various surfaces of the foam strip since the foam strip has to be placed in a tank, must be immersed in fluid and treated as a whole by a single pressure wave. Like the gas reticulation, the so-called shock reticulation proposed in U.S. Pat. No. 3,239,585 cannot be practiced in a continuous manner. Only the chemical method could in theory create a gradient of properties but it is very difficult to control and potentially hazardous to use.

For these reasons and disadvantages, there is a serious need for a method and for an apparatus for reticulating foams using shock waves in a gaseous environment to improve their acoustic and filtering properties, which is economical, simple to process, practiced in a continuous manner, offers the potential to produce functionally graded materials and is easily implemented in the production or assembly line.

### SUMMARY

Accordingly, it is an object of the present disclosure to provide a process to reticulate foams in a gaseous environment to improve the acoustic and filtering efficiency of the foams.

Another object of the present disclosure is to provide a process which can be applied in air (at room conditions).

Still another object of the present disclosure is to provide a process whereby the reticulation rate is controlled along thickness and/or surface for acoustic and filtering optimum performance.

A further object of the present disclosure is to provide a process for increasing the acoustic and filtering properties of foams which is economical, simple to process, practiced in a continuous manner and easily implemented in the production or assembly line.

An additional object of the present disclosure is to provide a process of increasing the softness, flexibility, and porosity of foams.

A still further object of the present disclosure is the provision of a process for reticulating closed-cell foams which requires no chemicals and is free of hazardous fumes and vapors.

Another object of the present disclosure is to provide an apparatus needed to reticulate foams using shock waves in a gas.

According to an embodiment, there is provided a process for improving the properties of closed-cell or partially closed cell foam, the process comprising: immersing the foam in a gaseous environment and impacting the foam with an energy impulse.

According to another embodiment, there is provided the process as described above, wherein the properties are acoustical properties.

According to another embodiment, there is provided the process as described above, wherein the properties are filtering properties.

According to another embodiment, there is provided the process as described above, wherein the energy impulse is a shock wave.

According to another embodiment, there is provided the process as described above, wherein the gaseous environment is air.

According to another embodiment, there is provided the process as described above, wherein the gaseous environment is ambient air.

According to another embodiment, there is provided the process as described above, wherein the gaseous environment is room condition air.

According to another embodiment, there is provided the process as described above, further comprising the step of: controlling the reticulation rate along the thickness of the foam.

According to another embodiment, there is provided the process as described above, wherein the energy impulse is applied uniformly on one side or on both sides of the foam to give a reticulation rate with symmetric properties along the thickness of the foam.

According to another embodiment, there is provided the process as described above, wherein the reticulation rate is controlled along the surface of the foam to create zones with different properties.

According to another embodiment, there is provided the process as described above, wherein the energy impulse is generated closely adjacent the foam.

According to another embodiment, there is provided the process as described above, further comprising the step of perforating the foam before the energy impulse occurred.

According to another embodiment, there is provided the process as described above, further comprising the step of qualifying the properties of the foam after the energy impulse occurred.

According to another embodiment, there is provided a shock wave generator for reticulating a material to be treated comprising: a primary section filled with a high pressure gas; a secondary section filled with a low pressure gas, peripherally extending from the primary section, the secondary section having an output; an impermeable partition impermeably separating the primary section and the secondary section; wherein when the impermeable partition is suddenly removed, a shock wave is generated and propagates in a gaseous environment in the output of the secondary section toward the material to be treated placed at the output of the secondary section.

According to another embodiment, there is provided the shock wave generator as described above, wherein the low pressure gas in an inert gas.

According to another embodiment, there is provided the shock wave generator as described above, further comprising an external supply pipe connected to the primary section for filling the primary section with the high pressure gas.

According to another embodiment, there is provided the shock wave generator as described above, wherein the impermeable partition comprises a breakable membrane.

According to another embodiment, there is provided the shock wave generator as described above, wherein the impermeable partition comprises a valve.

According to another embodiment, there is provided the shock wave generator as described above, wherein the high pressure gas comprises air, nitrogen, reactive gas or a combination thereof.

According to another embodiment, there is provided the shock wave generator as described above, wherein the high pressure gas comprises helium.

According to another embodiment, there is provided the shock wave generator as described above, wherein the low pressure gas comprises air.

According to another embodiment, there is provided the shock wave generator as described above, wherein the low pressure gas comprises argon.

According to another embodiment, there is provided the shock wave generator as described above, wherein the pressure of the high pressure gas is precisely controlled when the impermeable partition is suddenly removed for generating the shock wave to generate shock wave of a desired strength.

According to another embodiment, there is provided a foam reticulating system for treating a closed-cell or partially closed cell foam for increasing the acoustical or filtering properties of the foam, the system comprising: a conveyor for displacing the foam in a gaseous environment; a shock wave generator for impacting the foam with a shock wave travelling in the gaseous environment.

According to another embodiment, there is provided the foam reticulating system as described above, further comprising sensor device for qualifying the properties of the foam after impact from the shock wave.

According to another embodiment, there is provided the foam reticulating system as described above, further comprising a perforation device for perforating the foam prior to impact from the shock wave.

Features and advantages of the subject matter hereof will become more apparent in light of the following detailed description of selected embodiments, as illustrated in the accompanying figures. As will be realized, the subject matter disclosed and claimed is capable of modifications in various respects, all without departing from the scope of the claims. Accordingly, the drawings and the description are to be regarded as illustrative in nature and not as restrictive and the full scope of the subject matter is set forth in the claims.

### BRIEF DESCRIPTION OF THE DRAWINGS

Further features and advantages of the present disclosure will become apparent from the following detailed description, taken in combination with the appended drawings, in which:

FIG. 1A is a cross-sectional schematic view of a shock wave generator in accordance with an embodiment;

FIG. 1B is a cross-sectional schematic view of a shock wave generator in accordance with another embodiment;

FIG. 2 is a cross-sectional schematic view of foam reticulating system for performing the process of reticulating materials using a shock wave in a gaseous environment;

FIG. 3A is a perspective schematic view of a foam reticulating system implementing the process of reticulating materials using a shock wave generator in accordance with another embodiment;

FIG. 3B is a perspective schematic view of a foam reticulating system implementing the process of reticulating materials using various shock wave generators in accordance with another embodiment;

FIG. 3C is a perspective schematic view of a foam reticulating system implementing the process of reticulating materials performing various shock wave treatments with one shock wave generator in accordance with another embodiment;

FIG. 3D is a cross-sectional schematic view of a foam reticulating system implementing a process of reticulating materials performing multiple shock wave treatments using multiple shock wave generators in accordance with another embodiment;

FIG. 4 is a graphic illustration of the foam sound absorption efficiency according to the frequency before and after treatment;

FIG. 5A is a photography showing a magnified view of a partially closed-cell foam;

FIG. 5B is a photography showing a magnified view of a partially closed-cell foam after shock treatment; the foam becomes open cells.

FIG. 6A is a schematic view of a foam reticulating system implementing a static process of reticulating materials using a shock wave in a gaseous environment in accordance with another embodiment;

FIG. 6B is a schematic view of a foam reticulating system implementing a continuous process of reticulating materials using a shock wave in a gaseous environment in accordance with another embodiment; and

FIG. 7 is a cross-sectional schematic view of a mechanical perforation machine for implementing a process of reticulating materials using a shock wave in a gaseous environment including a step of mechanically perforating the material before shock wave treatment, in accordance with another embodiment.

It will be noted that throughout the appended drawings, like features are identified by like reference numerals.

### DETAILED DESCRIPTION

In an embodiment there is disclosed a shock wave generator apparatus for reticulating materials, such as foams, using shock waves in a gaseous environment. The shock wave generator apparatus may improve numerous properties such as acoustical properties and filtering properties of a foam.

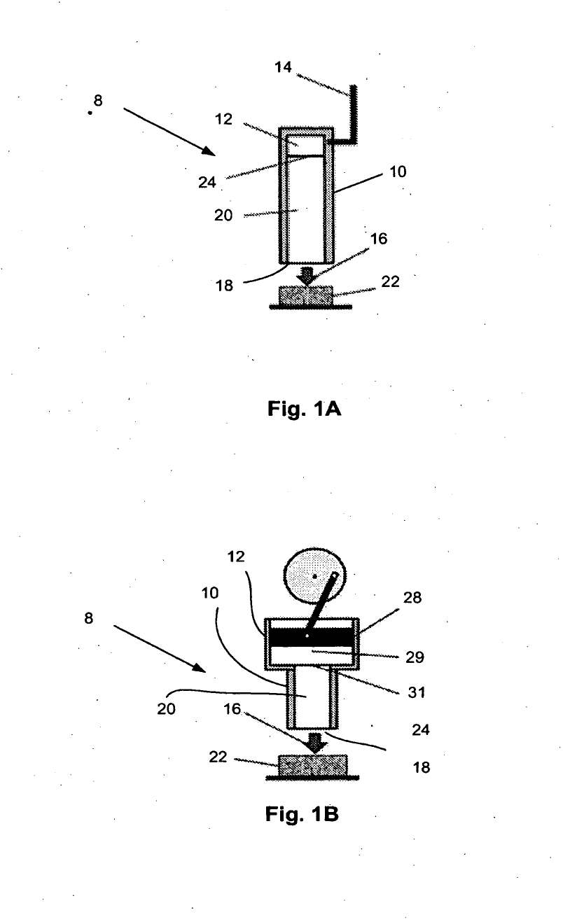

Referring now to the drawings, and more particularly to FIGS. 1A and 1B, there is shown a cross-sectional schematic view of shock wave generator 8. The shock wave generator 8 includes a shock tube 10, which is used to generate a controlled shock wave 16 in a gaseous medium. It is to be noted that the shock wave 16 may also be designated by any kind of energy impulses. One type of shock tube 10 uses two sections, a primary section 12 and a secondary section 20, peripherally extending from the primary section 12. The primary section 12 of the shock tube 10 is filled with a high pressure gas from an external supplier pipe 14. As shown in FIG. 1B, the high pressure gas of the primary section 12 of the shock tube 10 may also be generated from an explosion or combustion within the primary section 12, or by driving a piston 28 into this primary section 12 trough the valve 31 for generating compressed gas 29. A great amount of energy is thus accumulated in this primary section 12. The primary section 12 is separated from a secondary section 20 via an impermeable partition 24, such as a breakable membrane or a valve 31. On the other hand, the secondary section 20 is filled with low pressure gas. The low pressure gas may be air at room conditions. It is to be noted that the low pressure gas may be any other gas such as, without limitations, helium, argon, carbon dioxide or nitrogen. When the impermeable partition 24 is suddenly removed, a shock wave 16 is generated and propagates in the secondary section 20 toward surface of the material to be treated 22 placed at the output 18 of the secondary section 20. A precise control of the pressure of the primary section 12 at rupture is used to generate shock waves 16 of desired strength.

In another embodiment (not shown), the shock tube 10 may use a single section filled completely or partially with detonable gas, or comprising a condensed phase explosive charge at the upstream end of the shock tube 10. The initiation of a detonation in the gas or charge at the upstream end of the shock tube 10 causes the propagation of a shock wave 16 downstream of the shock tube 10. The properties of this shock wave 16 may be controlled by changing the physical and chemical properties of the detonating medium.

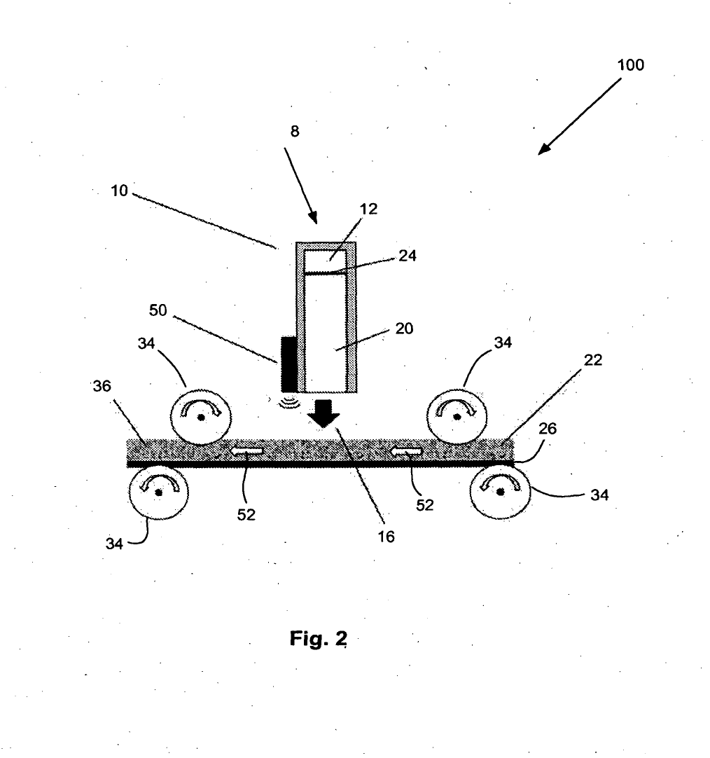

Referring now to FIG. 2, there is shown a foam reticulating system 100 comprising a shock wave generator 8 for performing the continuous process of reticulating materials, i.e., foams, using a shock wave 16 in a gaseous environment. In FIG. 2, the continuous process foam reticulating system 100 includes a sensor device 50, such as for example, without limitations, an in-situ acoustic emitter/receiver device, to control the quality of the shock treatment according to the shock wave 16 effect on the treated material 36. The sensor device may also be, without limitations, a pressure transducer, a thermocouple, an ultrasound based emitter and receiver to measure key foam acoustic properties (porosity, tortuosity, flow resistivity), a microphone, an acoustic particle displacement sensor, an acoustic antenna, a video camera to infer mechanical properties and open cell content, a mechanical properties sensor device (laser vibrometer, accelerometer) and the like. It is to be noted that the sensor device 50 is positioned after the shock wave treatment in the continuous process foam reticulating system 100. The sensor device 50 may also be fixed on the shock wave generator 8 to qualify the properties of the treated material 36 after the shock wave treatment occurs in the continuous process foam reticulating system 100.

Criteria measured using the sensor device 50 may be, without limitations, the sound absorption coefficient and/or the airflow resistivity and/or mechanical stiffness. In the process of reticulating materials using a shock wave 16 in a gaseous environment, the material to be treated 22, such as foams, may move in a flow direction represented by arrows 52 via the conveyor 26 and the rollers 34. Indeed, the material to be treated 22, by moving in the flow direction 52, is treated by the shock wave 16 of the shock wave generator 8 to become the treated material 36. It is to be noted that the material to be treated 22 may be foams of closed-cells or partially closed-cells. In the other hand, the treated material 36 may be foams of open-cells or partially open cells.

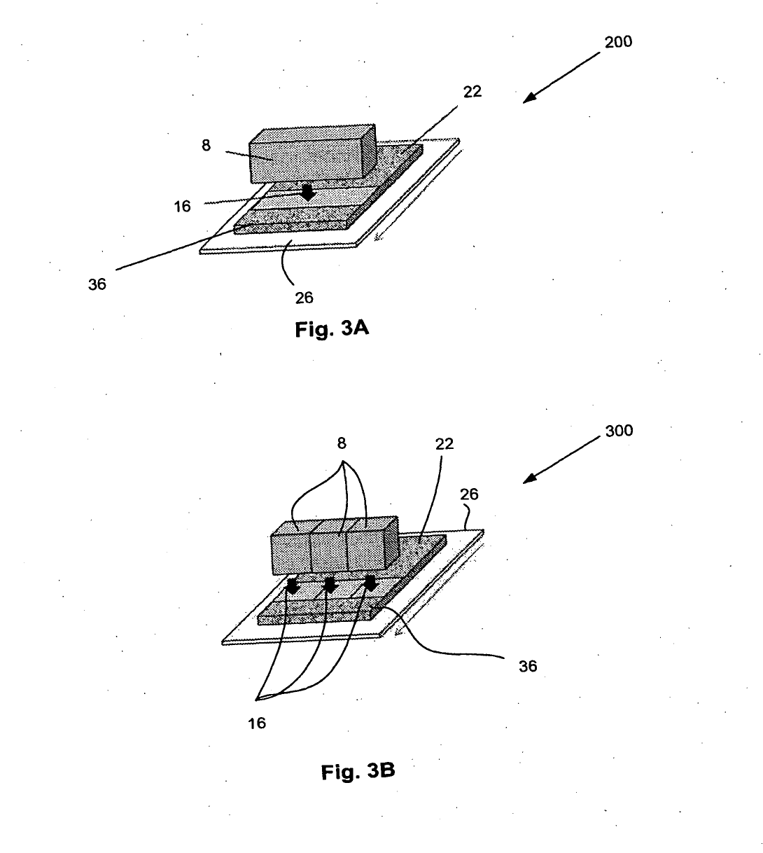

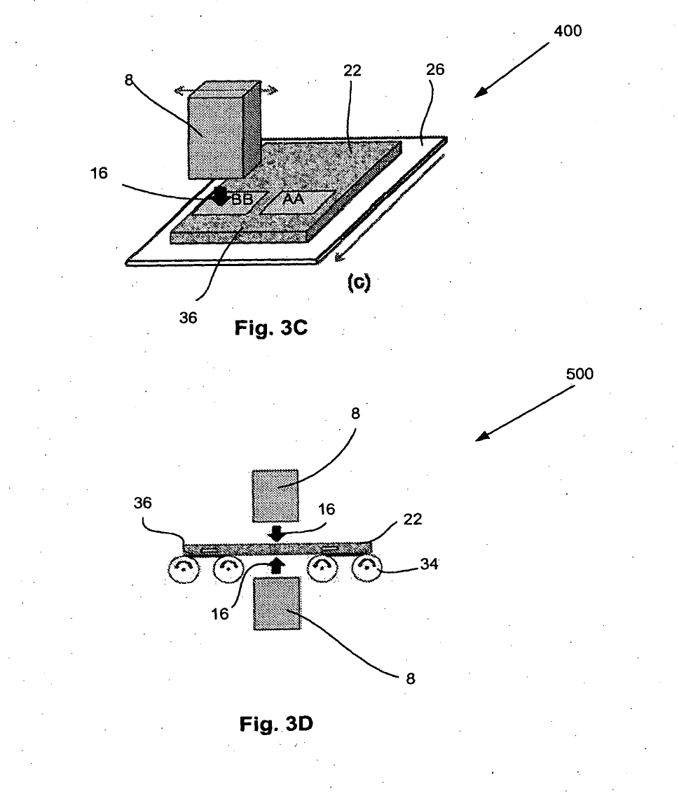

Different processes to reticulate the foam are illustrated in FIGS. 3A, 3B, 3C and 3D. FIG. 3A presents a continuous process foam reticulating system 200 to treat a large surface of the material to be treated 22 using only one shock wave generator 8. The surface of treated material 36 treated by the continuous process foam reticulating system 200 depends in this case on the size of the shock wave generator 8 and its produced shock wave 16 and it is thus limited. In the continuous process foam reticulating system 200, the material to be treated 22, such as foams, moves in a flow direction via the conveyor 26.

Referring now to FIG. 3B, a larger surface with various shock treatments may be achieved by using various shock wave generators 8 in the continuous process foam reticulating system 300. This configuration allows reticulating large surfaces of the material to be treated 22 and if needed have various reticulation rates (penetration rates) for different areas or a double porosity effect depending on the shock wave strength generated by each shock wave generators 8 and its shock wave 16. In the continuous process foam reticulating system 300, the material to be treated 22, such as foams, moves in a flow direction via the conveyor 26 to be transformed in a treated material 36. A movable shock wave generator 8 can reach equal performance compared to the aforementioned foam reticulating systems 200 and 300 involving various shock wave generators 8 as shown in FIG. 3C.

In the continuous process foam reticulating system of FIG. 3C, the single shock wave generator 8 moves between a first position AA and a second position BB to treat a large surface of the material to be treated 22. Finally, if a symmetric reticulation along the material thickness is required, a shock treatment with equal strength can be applied on both faces of the material to be treated 22. This can be done using the shock wave generator of FIG. 3A on both faces after reversing the material to be treated 22 or at the same time by using two shock wave generators 8 as shown in the continuous process foam reticulating system 500 of FIG. 3D. It is to be noted that the continuous processes foam reticulating system 200, 300, 400 and 500 may be mechanically continuous process foam reticulating systems or continuous process foam reticulating systems operated by an operator.

Foam properties before and after wave shock treatment. The shock wave has a considerable effect on the microstructure and thus on the non-acoustic properties of the foam. Table 1 shows these properties before and after wave shock treatment. It is shown that the wave shock has a real and important influence on the microstructure of the foam, which reduces the resistivity to the passage of air through the porous material and its tortuosity, slightly increasing its porosity and density because its thickness is slightly reduced.

TABLE 1
Properties of material to be treated and treated material

| Foam Properties | To be treated | Treated |
|---|---|---|
| Thickness (mm) | 25.6 | 18.4 |
| Density ρ (kg/m³) | 8.12 | 11.3 |
| Air Resistivity σ (Ns/m⁴) | 385 000 | 18 600 |
| Porosity | 0.96 | 0.99 |
| Tortuosity α_{∞} | 3 | 1.3 |
| Viscous length Λ (μm) | 300 | 50 |
| Thermal length Λ′(μm) | 300 | 340 |

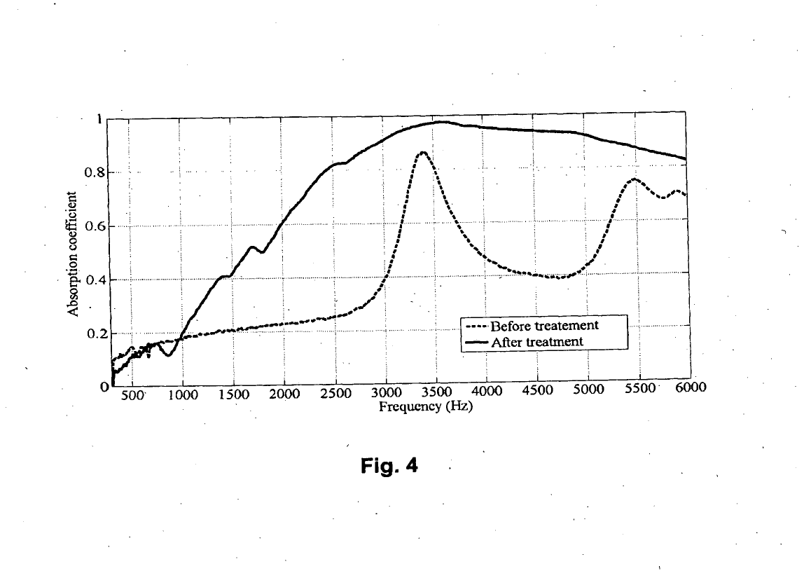

Referring now to FIG. 4, as an example, a 1 inch-thick flexible Polyimide foam with partially closed-cell, available on the open market, was treated in accordance with the shock wave generator 8. A standard impedance tube was used to measure the sound absorption coefficient before and after treatment. In this case, the aforementioned foam sample was treated on both faces to get symmetric reticulation properties. There is shown in FIG. 4 that the shock wave generator 8 and in accordance with the continuous process foam reticulating system 400 allows to substantially increasing the sound absorption efficiency. In particular, before treatment the absorption is poor and is only significant at mechanically controlled resonances, a behavior typical of partially closed cell foams. After reticulation, these resonances are eliminated and the absorption improved. The treated foam absorption coefficient is typical of an open cell foam and/or fibrous materials.

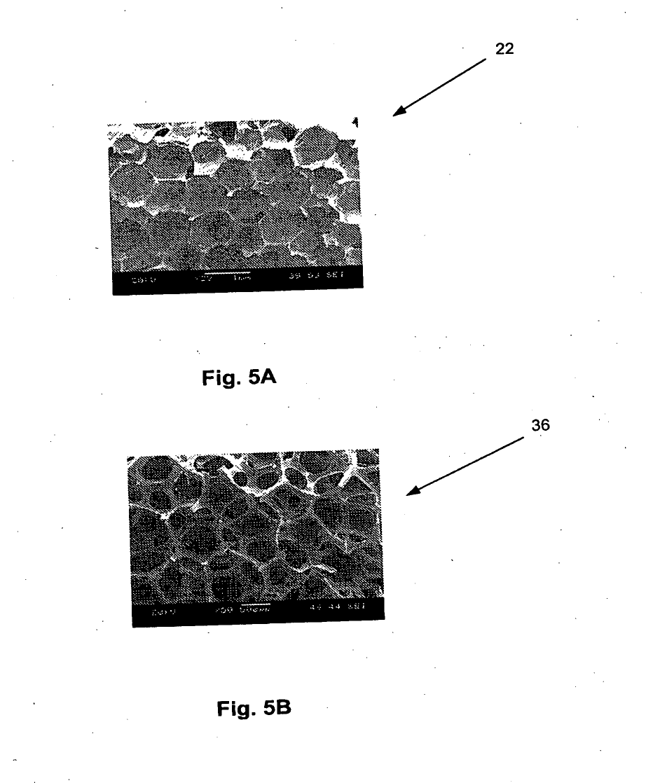

Referring now to FIG. 5A, there is shown a photography of a magnified view of a partially closed-cell foam, which may represent the material to be treated 22. On the other hand, according to FIG. 5B, there is shown photography of open-cells foam, which may represent the treated material 36. FIG. 5B clearly shows that the reticulation process eliminated the membranes closing the cells resulting in a more connected open pores, resulting in turn in low flow resistivity, less tortuous paths and better acoustic performance.

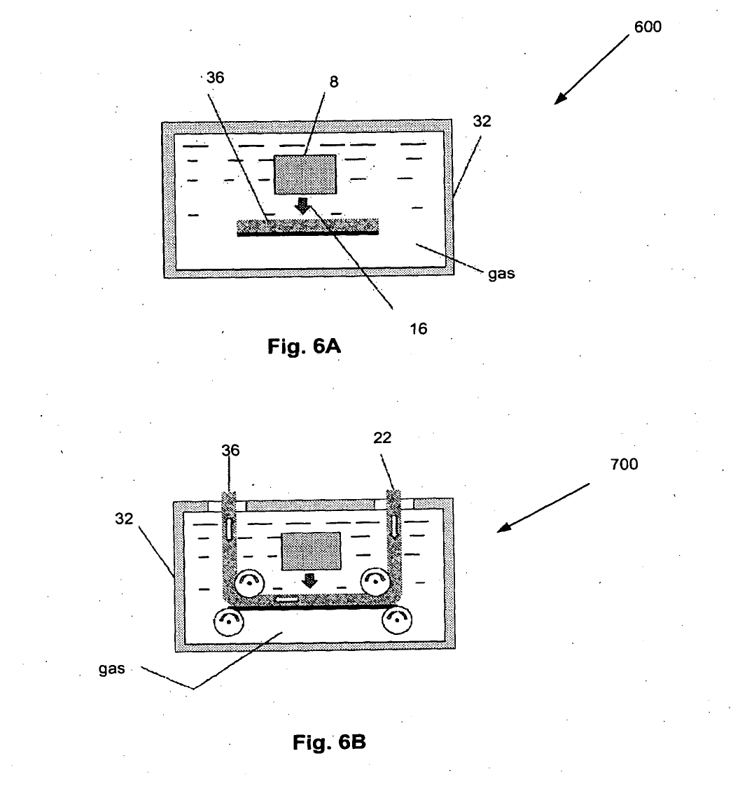

Referring now to FIG. 6A, there is shown a schematic view of a static process foam reticulating system 600 for reticulating materials using a shock wave 16 in a gaseous environment in accordance with another embodiment. As shown in FIG. 6A, the material to be treated 22 must be within the gas in which the shock wave 16 is generated. In this particular case, the enclosure 32 is used as an airtight tank if the gas is other than atmospheric air. In the case of atmospheric air, the enclosure 32 may be used as an acoustic barrier to protect the operator of the static process 600 from the shock wave 16.

Referring now to FIG. 6B, there is shown a schematic view of a continuous process foam reticulating system 700 for reticulating materials using a shock wave 16 in a gaseous environment in accordance with another embodiment. In the latter case, the material to be treated 22 is fed to the shock wave generator so as to scan the entire surface. In this particular case, the enclosure 32 is used as an airtight tank if the gas is other than atmospheric air. In the case of atmospheric air, the enclosure 32 may be used as an acoustic barrier to protect the operator of the static process 600 from the shock wave 16.

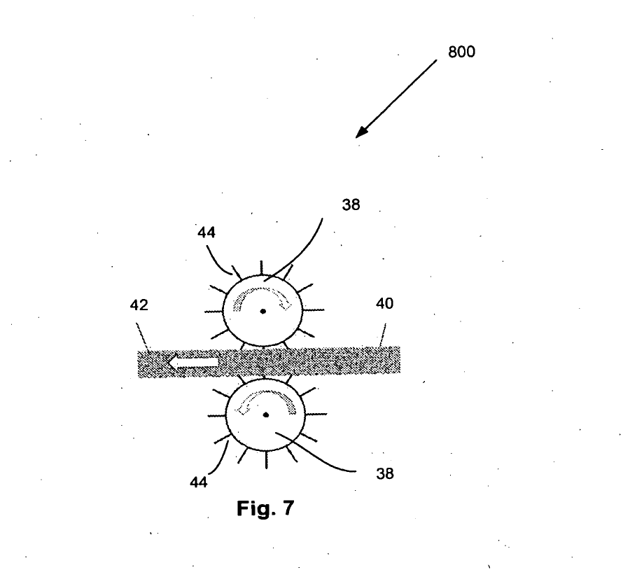

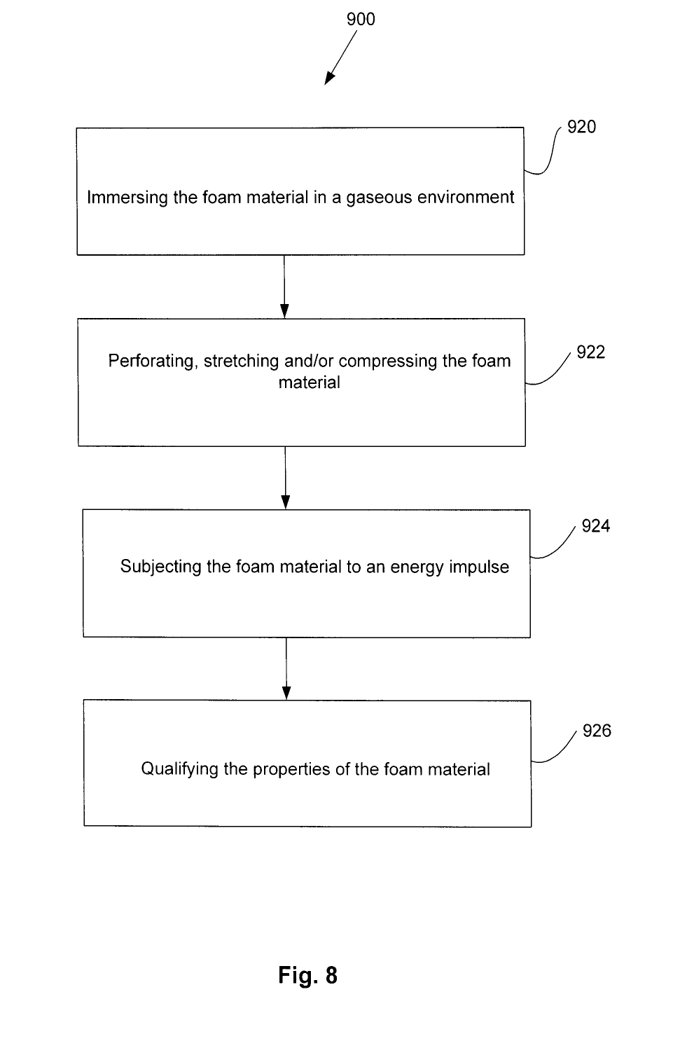

Referring now to FIG. 7, there is shown a cross-sectional schematic view of the pre-perforation machine 800 in accordance with another embodiment. The pre-perforation machine 800 represents the additional step of perforating the material to be perforated 40 before the shock wave treatment. Indeed, in the case of a porous material having a highly resistive flexible structure, in which the shock wave penetrates with difficulties, it is possible to perforate in advance the material and thereby facilitate the penetration of the shock wave. As a non-limitative example, in the pre-perforation machine 800 of FIG. 7, the material to be perforated 40 could pass between two perforation rollers 38 having picks 44 randomly distributed on their surface. It is to be noted that the example pre-perforation machine 800 may include one or a plurality of perforation rollers 38.

Additionally, the perforation rollers 38 may be made, without limitations, of a metallic material, or of any suitable material which have properties to allow perforation of the material to be perforated 40. The perforated material 42 is then ready to be treated. Instead of using perforation rollers, the pre-perforation machine 800 may operate, for example, using high-pressure water jets, lasers or other similar devices.

Finally, it is possible to integrate to the continuous process foam reticulating system 100 of reticulating materials using a shock wave 16 in a gaseous environment a foam reticulation quality control device, such as an acoustic device, for example (see FIG. 2). This control system can be the sensor device 50 and would measure during treatment or immediately after treatment the acoustic performance of the treated material 36. In the where the sensor device 50 is an acoustic device, the sensor device 50 can use the shock wave 16 of the shock wave treatment as a source or generate its own noise with a secondary audio source (i.e., speaker). The control sensors, which allow the acoustic properties measurement (e.g., absorption coefficient), can be microphones or other measurement probes.

The present invention will be more readily understood by referring to the following, examples which are given to illustrate the invention rather than to limit its scope.

While preferred embodiments have been described above and illustrated in the accompanying drawings, it will be evident to those skilled in the art that modifications may be made without departing from this disclosure. Such modifications are considered as possible variants comprised in the scope of the disclosure.

1. A process for improving properties of closed-cell or partially closed cell foam material, the process comprising: immersing the foam material in a gaseous environment and subjecting the foam material to an energy impulse.

2. The process of claim 1, wherein subjecting the foam material to an energy impulse comprises subjecting the foam material to a shock wave.

3. The process of claim 1, wherein immersing the foam material in a gaseous environment comprises one of: immersing the foam material in air, immersing the foam material in air at ambient temperature, and immersing the foam material in air at room conditions.

4. (canceled)

5. (canceled)

6. The process of claim 1, wherein the subjecting comprising applying the energy impulse uniformly on one side or on both sides of the foam material having a thickness to give a reticulation rate with symmetric properties along the thickness of the foam material or a varying reticulation rate along the thickness of the foam material.

7. (canceled)

8. (canceled)

9. The process of claim 1, wherein the subjecting comprises subjecting the foam material to energy impulses on various zones of the foam material thereby creating zones with different properties.

10. The process of claim 1, wherein the subjecting comprises subjecting a zone of the foam material to one or a plurality of energy impulses.

11. The process of claim 1, wherein the subjecting comprises subjecting the foam material to the energy impulse with one of: a normal incidence, an oblique incidence and a tangential incidence.

12. (canceled)

13. The process of claim 1, further comprising at least one of: perforating, compressing and stretching the foam material prior to subjecting the foam material to an energy impulse.

14. (canceled)

15. A shock wave generator for reticulating a material immersed in a gaseous environment, the shock wave generator comprising:
a primary section filled with a high pressure gas;
a secondary section filled with a low pressure gas;
an impermeable partition impermeably separating the primary section and the secondary section;
wherein when the impermeable partition is suddenly removed, a shock wave is generated and propagates in the gaseous environment toward the material.

16. The shock wave generator of claim 15, wherein the secondary section comprises an output and wherein the shock wave generator further comprises a rigid backing for closing the output of the secondary section and for receiving the material in the secondary section.

17. The shock wave generator of claim 15, further comprising an adjustable frame holding the primary section and the secondary section at an angle relative to a surface of the material and wherein the material impinged by the shock wave propagating at the angle.

18. (canceled)

19. The shock wave generator of claim 15, wherein the low pressure gas in the secondary section comprises an inert gas.

20. (canceled)

21. The shock wave generator of claim 15, wherein the impermeable partition comprises one of a breakable membrane and a valve.

22. The shock wave generator of claim 15, wherein the high pressure gas comprises one of: air, nitrogen, reactive gas, or any combination thereof.

23. The shock wave generator of claim 15, wherein the low pressure gas comprises one of air and argon.

24. A foam material reticulating system for treating a closed-cell or partially closed cell foam material for increasing acoustical or filtering properties of the foam material, the foam material reticulating system comprising:
a conveyor for displacing the foam material in a gaseous environment;
a shock wave generator for subjecting the foam material to a shock wave travelling in the gaseous environment.

25. The foam material reticulating system of claim 24, further comprising a sensor device for qualifying the properties of the foam material after impact from the shock wave.

26. The foam material reticulating system of claim 24, further comprising at least one of: a perforation device, a compression device and a stretching device for respectively perforating, compressing or stretching the foam material prior to impact from the shock wave.

27. The foam material reticulating system of claim 24, wherein the shock wave generator comprises a plurality of shock wave generators.

28. The foam material reticulating system of claim 27, wherein at least one shock wave generator of the plurality of shock wave generators is positioned over a first side of the foam material and wherein at least another shock wave generator of the plurality of shock wave generators is positioned over a second side of the foam material.

29. (canceled)
